(19) United States
(12) Patent Application Publication
(10) Pub. No.: US 2005/0208189 A1
(43) Pub. Date: Sep. 22, 2005

(54) Extract of by-products of the treatment of nuts and pulses, method for the production thereof and use of the same

(76) Inventors: Kathleen Kurschner, Schonwalde (DE); Thomas Eller, Berlin (DE); Christian Christiansen, Berlin (DE); Wolfram Waibler, Berlin (DE); Heinz-Dieter Isengard, Nurtingen (DE)

Correspondence Address: Luke A Kilyk;Kilyk & Bowersox, 53 A East Lee Street, Warrenton, VA, 20186, US

(21) Appl. No.: 10/519,156

(22) PCT Filed: Jun. 18, 2003
(86) PCT No.: PCT/EP03/06488

§ 371 Date: Dec. 17, 2004

(30) Foreign Application Priority Data
Jun. 18, 2002 (DE) 102 27 151.8

(51) Int. Cl. A23P 1/00

(52) U.S. Cl. 426/489

(57) ABSTRACT

The invention relates to an extract obtained from by-products of hard-shelled fruit and pulse processing characterised in that the by-products are selected from membranes and fruit residues of hard-shelled fruit, pulses or mixtures thereof, a method for producing the extract and its use as a colorant or additive, especially in foods, and for the production of coating films.

The present invention relates to an extract obtained from the by-products of hard-shelled fruit and pulse processing, a method for its production and the use of the extract.

The wood, dark brown on the outside and blood-red inside, of the sandalwood tree (Pterocarpus santalinus), which is widespread in East Asia and Africa, was earlier used for the dyeing of clothes and leather (Russia leather). Colorant components are santalin A, B and C, which are obtained by extraction using hexane, chloroform or ethanol (J. Verghese, Santalin—a peerless natural colorant, Cosmetics & Toiletries 1986, 101, 69-74).

Depletion resulting from its increased industrial use (dye extracts, fragrance oils, cosmetic articles) means that the sandalwood tree is now so rare that it is now a protected species (International Union of Conservation of Nature and Natural Resources [IUCN]: Red List Category and Criteria EN B1+2d, e). In addition, extracts from sandalwood can cause allergic skin reactions (A. Sandra, S. D. Shenoi and C. R. Srinivas, Allergic contact dermatitis from red sandalwood [Pterocarpus santalinus], Contact Dermatitis, 1996, 34, 69). Moreover, in discussion they are regarded as not being completely safe in terms of health (see J. Verghese, Santalin, ibid.).

In spite of the problems described, sandalwood extract is normally used today as a colorant in the snack industry since, compared with other food dyes, it has the technological advantage that it forms a film as it dries on the product, which prevents the adhesion of extrudates to each other before the drying process.

Hard-shelled fruits are types of fruit in which the edible seed is enclosed by an inedible hard shell. These include nuts in particular. When hard-shelled fruits and pulses are processed, the by-products include membranes and fruit residues. FR-A-2544593 relates to a food that is obtained from chopping up the fibrous parts of nuts.

The object of the present invention is to provide a suitable substitute for sandalwood extract which also demonstrates the above-mentioned technological advantages and can be obtained from a raw material which is available without limitation.

This object is solved according to the invention by an extract obtained from by-products of hard-shelled fruit and pulse processing which is characterised in that the by-products are selected from membranes and fruit residues of hard-shelled fruit, pulses or mixtures of these. The hard-shelled fruits are preferably nuts.

Examples of nuts of which the membranes and/or fruits can be used for the production of the extract according to the invention include walnuts, hazelnuts, peanuts, chestnuts, cashew nuts, almonds, brazil nuts and pistachios. Hazelnuts (genus: Corylus) are preferred; in particular, hazelnuts from the hazel bush Corylus avellana L. cultivated in northern climates are particularly preferred.

For use in foods, hard-shelled fruits, especially hazelnuts, are generally roasted without their shells. The associated browning of the hard-shelled fruits is influenced by the raw material composition, the roasting temperature, moisture content and pH value.

Large quantities of raw material are available, for example, as a by-product of the production of spreads for bread.

According to the invention, an extract is produced from the by-products of the processing of hard-shelled fruits and pulses which are preferably roasted.

As a particular preference, according to the invention, a red-brown, strongly coloured extract can be obtained through extraction from by-products of hazelnut roasting (roasted seed shells [Lat. testa]). The typical dry matter content of the extract in unconcentrated form is in the range of 0.1 to 20%, preferably in the range of 0.5 to 10%, and in particular from 1 to 5%. After concentration, the dry matter content of the liquid extract is usually 10 to 30%, preferably 15 to 27%, and the dry matter content of the dry extract is usually 80 to 100%, preferably 85 to 98%.

The raw extract usually contains minerals, proteins, fats, roughage and carbohydrates in different quantities depending on the extraction conditions and quality of the raw materials.

The present invention also relates to a method for the production of the extract according to the invention, including the extraction of the by-products of the processing of hard-shelled fruits and pulses.

The extraction of the by-products of hard-shelled fruit and pulse processing can be carried out in stages or continuously; it is preferably carried out in stages. Water or organic solvents may be used as the extraction medium, alone or in various mixtures. Examples of organic solvents include alcohols, such as methanol, ethanol, propanol and mixtures of these. Ethanol is used preferably as the organic solvent. Water, if necessary in combination with alcoholic solvents, preferably ethanol, is particularly preferred. Particularly preferred are mixtures of water and ethanol in ratios from 70:30 to 30:70 (m/m).

Extraction is generally carried out at atmospheric pressure and at temperatures from 20 to 95° C., preferably from 30 to 80° C., and particularly preferably from 40 to 70° C.

Extraction can be carried out with normal equipment in a known way. Extraction in stages can be carried out for example in a mashing tub or in a flow extraction plant.

Continuous extraction can be carried out for example by counterflow extraction, preferably in a carousel extractor.

The extraction of the by-products of hard-shelled fruit and pulse processing produces a raw extract which can be used in unconcentrated form, in an increased concentration or in dried form or is reprocessed, depending on the application. Reprocessing may include, for example, normal purification stages, such as decanting, centrifuging and filtration, in order to separate out suspended matter.

The raw extract purified in this way can then be concentrated for example by evaporation in order to produce a concentrated extract or a dry extract. To produce a dry extract, the solvent can be removed from the raw extract, the purified raw extract or the concentrated extract for example by spray drying, freeze drying or vacuum drying.

To produce the dry extract, usual adjuvants, such as carrier materials, can be added to the raw material.

Suitable carrier materials for the dry extract include carbohydrates such as maltodextrin, glucose, modified starch, dextrin, saccharine and lactose, as well as lecithin, alginates, gum tragacanth, gum arabic, glucitol, pectins and cellulose derivatives. Water-soluble carrier materials are preferred.

The dry extract can also be formulated, in particular with spray drying, with or without carrier material, according to the usual methods, as a powder or granulate that is stable in storage and easily dissolved in water.

The extract according to the invention can be used as a colorant or additive in both foods and non-foods. Both the raw extract and the concentrated extract and dry extract are suitable for this.

The extract according to the invention can be used for example for the colouring of foods, such as extruded and, if applicable, deep-fried snack products, gelatine articles, hard caramels, milk products, drinks such as lemonades/carbonated drinks and fruit juice drinks, and baked products such as bread, cakes and biscuits.

In addition, the extract according to the invention from by-products of hard-shelled fruit and pulse processing is also suitable for use for the colouring and/or coating of pharmaceutical preparations such as tablets, capsules and granulates.

The extract according to the invention can also be mixed with other colouring extracts such as onion and/or malt extract in order to achieve the desired colour.

In the non-food sector, the extract according to the invention can be used for example in products in the paper or wood industry, in particular as an additive or colorant.

The raw extract has a red-brown colour which is comparable to the colour strength of caramel (colorant E150d) (definition according to Directive 95/45 EC, 07/26/95). Its colorant qualities can be varied from yellow, orange, red, red-brown to dark brown by changing the pH and the dosage in the range from 1 to 14.

In addition, the extract according to the invention is suitable, because of its extraordinary heat and light stability, as a substitute for anthocyan-based, carmine-based and synthetic colours at an acid pH, and for carmine-based and synthetic colours also at a neutral pH. The allergenic potential of the extract according to the invention is extremely low. The extract is hypoallergenic.

It was also found that the extract according to the invention obtained from by-products of hard-shelled fruit and pulse processing can stabilise anthocyans and/or anthocyanidins. In particular, the extract according to the invention can stabilise anthocyans and/or anthocyanidins to prevent decomposition under the influence of light.

Anthocyans are a group of chemically related blue, violet and red colorants (benzopyrylium salts), very common in the plant world, which are dissolved in the cellulose of blossoms and fruits and occasionally also in sprout axes and leaves of plants and which create the colourings that typify these. In chemical terms, anthocyans are glycosides of the actual chromophores, the anthocyanidins.

All the known anthocyanidins have as their basic structure the C-4′ hydroxylated 2-phenyl chromene (shown in the primary structure as flavylium cation):

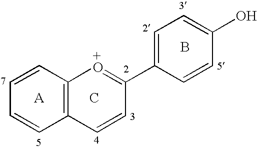

The anthocyanidins are derived from three basic structures: pelargonidin, cyanidin and delphinidin, which differ from each other through their different substitution in the B-ring. In addition, 3-desoxyanthocyanidins are also known (see, e.g., Römpp Lexikon Chemie, 10th edition, 1996-1999, p. 210-212).

Examples of anthocyanidins which occur in many different plants and plant parts include pelargonidin, cyanidin, delphinidin, apigenin, paeonidin, petunidin, malvidin, hirsutidin and tuberidin.

The extract according to the invention can considerably improve the light stability of the listed anthocyans and anthocyanidins.

Preferably, the extract according to the invention is used for improving the light stability of juices and/or juice concentrates from fruits and vegetables containing anthocyan and/or anthocyanidin, such as: blackcurrants, cherries, elderberries, aronia berries, red grapes, hibiscus, black carrots, red cabbage, purple potatoes and sweet potatoes.

The extract according to the invention obtained from by-products of hard-shell fruit and pulse processing is extremely strongly coloured, stable in storage, fast-drying, stable in deep-frying and represents an outstanding substitute for sandalwood extract, which is expensive and difficult to obtain, particularly because the extract according to the invention presents not only colouring but also film-forming properties which are comparable with those of the sandalwood extract. That means that the extract according to the invention obtained from by-products of hard-shell fruit and pulse processing dries like the sandalwood extract on surfaces, especially starch pellets, quickly and forms a film, which is crucial for its application on food surfaces and other particle surfaces, since the adhesion of particles is prevented. The extract according to the invention has the advantage over sandalwood extract that it is still stable in the lower pH range below 5 and that it is obtained from cheap raw materials which are available without limitation.

### EXAMPLE 1

13 g roasted hazelnut membranes are mixed with 150 g water and 30 g ethanol (94.6% by mass) and stirred for 2 hours at 75° C. After separation of the pomace, the resulting raw extract is filtered using a fluted filter. Through evaporation using a rotation evaporator, 10 g of extract concentrate with 25.2% dry matter (according to Art. 35 LMBG (German Food and Commodities Law) L 03.00-9) was obtained.

### EXAMPLE 2

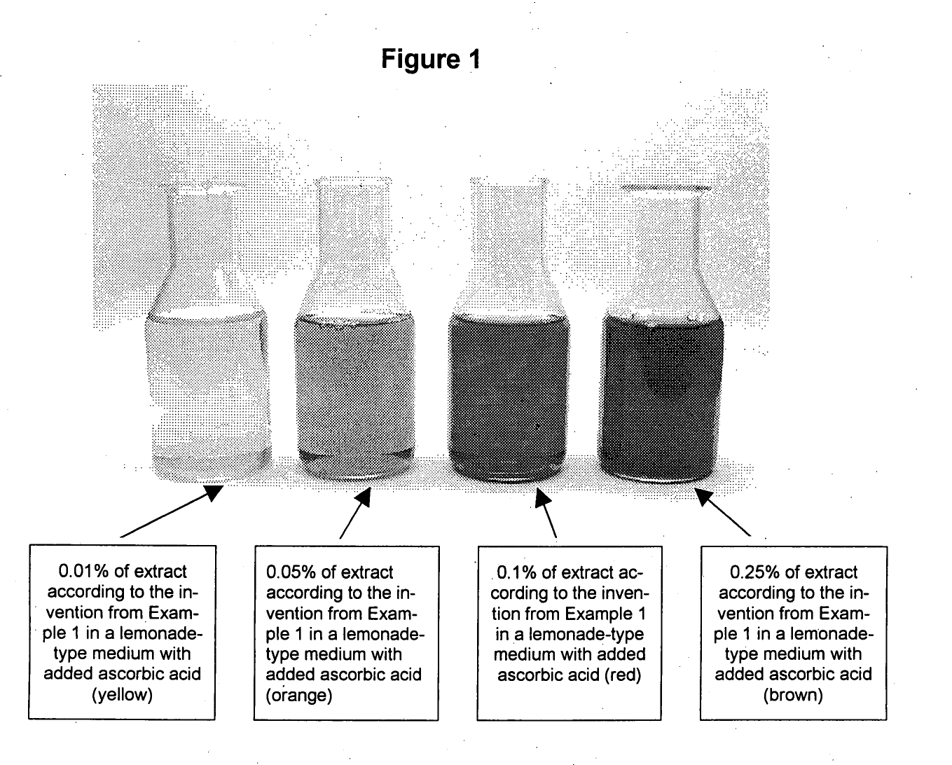

140 g invert sugar syrup, 14 g citric acid solution (50%), 0.15 g ascorbic acid were filled to 1000 g with demineralised water. The medium was kept at a temperature of 23° C. and set to a pH of 3.00 with NaOH solution (50%). A 702 SM Titrino (Metrohm, Herisau, Switzerland) with a glass electrode was used to measure the pH. The extract according to the invention from Example 1 was added to the resultant lemonade-type medium with the addition of ascorbic acid and was easily dissolved by stirring. As shown in FIG. 1, the colour shades yellow, orange, red and brown were produced depending on the dosage (0.01, 0.05, 0.1, 0.25% by mass).

### EXAMPLE 3

The stability of the following colour extracts was examined under the influence of light in a lemonade-type medium with added ascorbic acid according to Example 2:
1 The extract according to the invention as in Example 1
2 Anthocyan-based red-yellow vegetable colour extract
3 Anthocyan-based red-blue fruit colour extract
4 Carmine-based colour extract, E120
5 Synthetic dye azorubin, E122

For this, the dilution of the colour extracts in the lemonade-type medium with the addition of ascorbic acid was chosen in such away that, for all the samples to be examined, a red colouring occurred in the area of an a* value of 44.3±0.5 (according to the ClE-L*a*b* system).

7 clear polystyrene Accuvettes (Beckmann Coulter GmbH, Krefeld; height: 5.6 cm, wall thickness: 1 mm, internal diameter: 30 mm, volume: 27 ml) were each filled with 25 ml of sample. The filled Accuvettes were placed in a temperature-maintained stainless steel tub in the floor of the light chamber of the Suntester lighting device (Atlas Suntester CPS, xenon lamp, 765 W/m², daylight filter: filter dish 65052381). A water/ethanol mixture (90/10, v/v) was used as the temperature-maintenance medium. The thermostat temperature was 23° C. At the beginning t₀ and after every hour t₁ . . . t₆, the colour values were measured with a Lico 200 spectrophotometer (Dr. Lange GmbH & Co. KG, Düsseldorf).

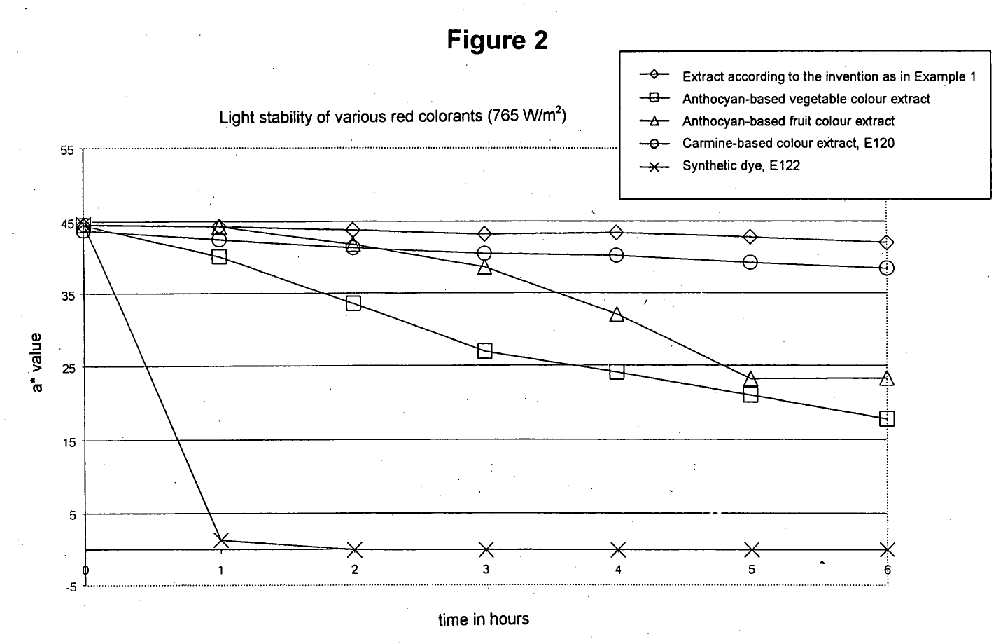

FIG. 2 shows the extraordinary light stability of the extract according to the invention from Example 1 in a lemonade-type medium with added ascorbic acid. In comparison with other colour extracts, the extract according to the invention shows, in the example named, the highest red-shade stability (a* value) under the influence of light.

### EXAMPLE 4

The stability of the following colour extracts in a lemonade-containing medium with added ascorbic acid under Example 2 was examined under the influence of heat:

1 The extract according to the invention as in Example 1

2 Anthocyan-based red-yellow vegetable colour extract

3 Anthocyan-based red-blue fruit colour extract

4 Synthetic dye azorubin, E122

For this, the dilution was selected in such away that, for all the samples to be examined, a red colouring occurred in the area of an a* value of 45.3+0.5. 6 closable reagent glasses (12 ml volume) were each filled with 10 ml of the sample and placed in a water bath at 90° C. (pasteurisation conditions). At the beginning, and after 1, 3, 5, 7 and 10 minutes, the colour values (according to the CIE L*a*b* system) were measured with a Lico 200 spectrophotometer (Dr. Lange GmbH & Co. KG, Düsseldorf).

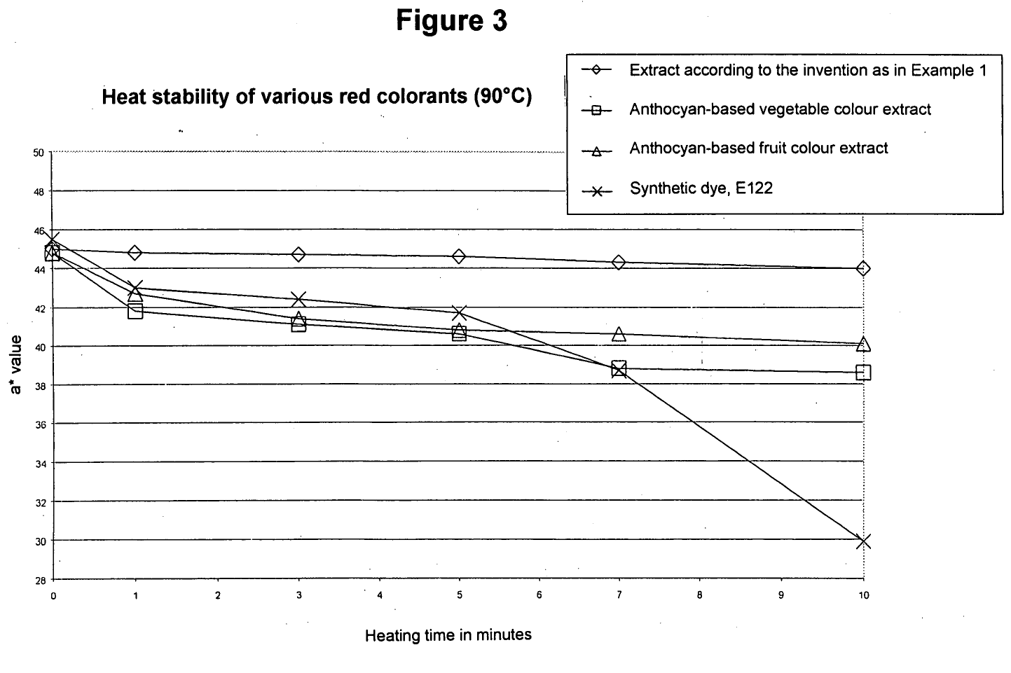

FIG. 3 shows the extraordinary heat stability of the extract according to the invention from Example 1 in a lemonade-type medium with added ascorbic acid. In comparison with other colour extracts, the extract according to the invention shows, in the example named, the highest red-shade stability (a* value) under the influence of heat.

### EXAMPLE 5

In an investigation of the extract concentrate from Example 1, a competitive ELISA test only showed very small quantities of the allergenic hazelnut protein (37+10 mg/kg).

For example, in the application of the extract concentrate from Example 1 as a colorant for deep-fried snacks (concentration: 0.05% by mass), the estimated daily consumption of hazelnut protein is, because of the low dosage, well below the limit of 720 μg assumed to trigger allergies (I. Malmeheden Yman et al., Analysis of food proteins for verification of contamination or mislabelling, Food Agric. Immunol., 1994, 6, 167-172; The little “Souci-Fachmann-Kraut” Food Table for practical use, WVG, Stuttgart, 1991). In order to reach the critical threshold value required to trigger an allergic reaction, between 37 and 64 packs (of 75 g each) of this product would need to be eaten.

The danger of triggering an allergic reaction for example by the consumption of a deep-fried snack product coloured with the extract concentrate from Example 1 is therefore relatively minor.

### EXAMPLE 6

100 g roasted hazelnut shells were mixed with 500 g ethanol (94.6% by mass). The mixture was stirred for 2 hours at 20° C. After separation of the pomace, the resulting raw extract was filtered using a fluted filter. Through evaporation using a rotation evaporator, 10 g of dry extract in powder form (95% dry matter) was obtained.

In a photometric determination according to Folin-Ciocalteu (V. L. Singleton et al., Analysis of total phenols and other oxidation substrates and antioxidants by means of Folin-Ciocalteu reagent, Methods in Enzymology, 1999, 299, 152-178), the total phenol content, calculated as gallic acid (Fluka Chemie GmbH, Buchs, Switzerland), is equivalent to 8.34% in relation to the dry matter.

### EXAMPLE 7

1 g of the powder obtained by spray drying of the hazelnut extract was dissolved in 100 ml demineralised water. 1 l of the lemonade medium (made according to Example 2) was added to 0 ml (reference), 2.2 ml (mixture A), 6.6 ml (mixture B), 11 ml (mixture C) of the redissolved hazelnut extract and coloured with 1 g elderberry juice concentrate. The light stability was compared as described in Example 3.

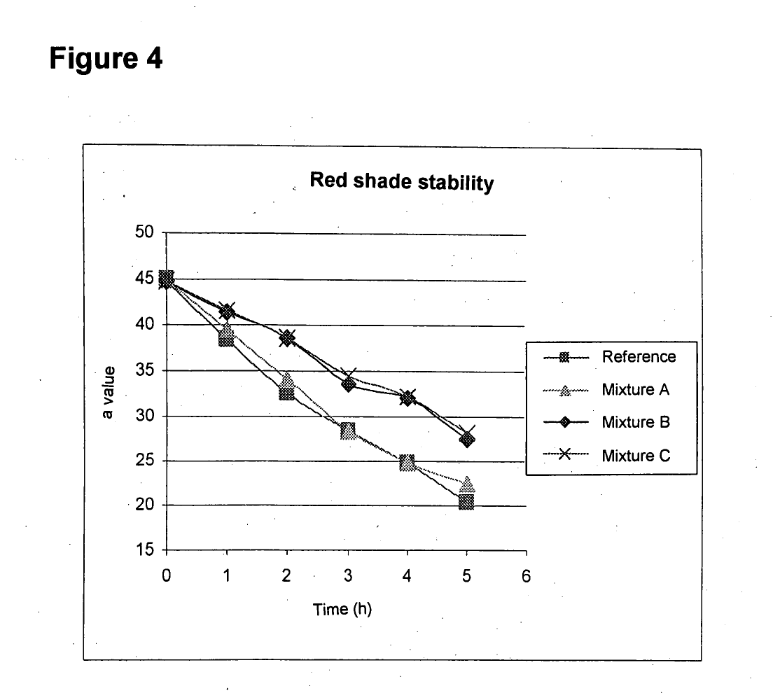

FIG. 4 shows that the addition of hazelnut extract powder in the quantity of mixture B and C can lower the red shade loss of the lemonade coloured by elderberry by around ⅓ after 5 hours in the Suntester.

1. Dry extract obtained from roasted by-products of hard-shelled fruit and pulse processing, whereby the by-products are membranes and/or fruit residues of hard-shelled fruits, pulses or mixtures thereof.

2. Dry extract according to claim 1, wherein said hard-shelled fruits are nuts.

3. Method for production of the dry extract according to claim 1, comprising the extraction of the by-products of hard-shelled fruit and pulse processing and drying of the extract.

4. Method according to claim 3, wherein the extraction is carried out in stages.

5. A method of coloring a product comprising the addition of the dry extract of claim 1 to the product.

6. A method to stabilise anthocyans and/or anthocyanidins comprising adding the dry extract of claim 1 to a product containing said anthocyans and/or anthocyanidins.

7. The method of claim 5, wherein said product is a food.

8. A method to form a film comprising applying said dry extract of claim 1 to a substrate to form said film.

9. A food product comprising the dry extract of claim 1.

10. The dry extract of claim 2, wherein said nuts comprise walnuts, hazelnuts, peanuts, chestnuts, cashew nuts, almonds, brazil nuts, pistachios, or a combination thereof.
